(19) United States
(12) Patent Application Publication
(10) Pub. No.: US 2013/0182729 A1
(43) Pub. Date: Jul. 18, 2013

(54) WAVELENGTH LOCKER DESIGN FOR PRECISE CHANNEL LOCKING OF A WIDELY TUNABLE LASER

(71) Applicants: Ruolin Li, Milpitas, CA (US); Wenjun Fan, Milpitas, CA (US)

(72) Inventors: Ruolin Li, Milpitas, CA (US); Wenjun Fan, Milpitas, CA (US)

(73) Assignee: Mars Technology

(21) Appl. No.: 13/349,513

(22) Filed: Jan. 12, 2012

(51) Int. Cl. H01S 3/10

(52) U.S. Cl. 372/20

(57) ABSTRACT

In accordance with aspects of the present disclosure, a method is disclosed. The method includes controlling an operational wavelength of a wavelength tunable laser by receiving radiation from the laser at first photo-detector including a first optical element having a partially reflective coating on a front surface of the first optical element; receiving at least a portion of the radiation partially reflected from the front surface of the first optical element at an etalon; receiving radiation from the etalon at a second photo-detector including a second optical element having an anti-reflection coating on a front surface of the second optical element; determining, by processor, a control signal to be applied to the laser to control the operational wavelength of the radiation based on data from the first and the second photo-detectors; and transmitting the control signal to the laser to, control the operational wavelength of the radiation.

### FIELD OF THE DISCLOSURE

The present application is directed to wavelength locker design for precise channel locking of a widely tunable laser

### BACKGROUND OF THE DISCLOSURE

Precise and stable wavelength control or lasing wavelength locking is an important function for wavelength tunable laser for its Wavelength Division Multiplexing (WDM) application in optical communication and wavelength swept optical sensing where accurate wavelength knowledge is needed for control and feedback of laser. Most wavelength locking sensors involve the use of etalons, beam splitters, and photodiodes or photo-detectors, all of which can be assembled on a sub-mount, for wavelength reference and control. An etalon is typically made of a solid state Fabry-Perot cavity with thickness determined by the Free-Spectrum-range (FSR) requirement and the coating defined by the desired finesse.

However, in actual application, performance and stability, cost, and form factor often become important. In this disclosure, a new design of wavelength locker is described that eliminates a need for a beam-splitter while maintaining a same photon flux on both photo-detectors for better stability and performance.

### SUMMARY OF THE DISCLOSURE

In accordance with aspects of the disclosure, a method is described that can include controlling an operational wavelength of a wavelength tunable laser by receiving radiation from the laser at first photo-detector including a first optical element having a partially reflective coating on a front surface of the first optical element; receiving at least a portion of the radiation partially reflected from the front surface of the first optical element at an etalon; receiving radiation from the etalon at a second photo-detector including a second optical element having an anti-reflection coating on a front surface of the second optical element; determining, by processor, a control signal to be applied to the laser to control the operational wavelength of the radiation based on data from the first and the second photo-detectors; and transmitting the control signal to the laser to control the operational wavelength of the radiation.

In some aspects of the present disclosure, the etalon can be a solid state etalon and can include a solid state Fabry-Perot cavity.

In some aspects of the present disclosure, the wavelength tunable laser is arranged to produce an optical signal for wavelength division multiplexing for optical communication.

In some aspects of the present disclosure, the method can include arranging the first and the second photo-detectors and the etalon on separate sub-assemblies.

In some aspects of the present disclosure, the partially reflective coating on the first optical element reflects about 50% of the incident light and the anti-reflection coating on the second optical element permits a maxima transmission.

In some aspects of the present disclosure, the second photo-detector can include an aperture that includes a dimension that is equal to or larger than an aperture of the first photo-detector.

In some aspects of the present disclosure, the processor can include a digital signal processor and can include a memory that is arranged to store a known spectrum of the etalon.

In some aspects of the present disclosure, the etalon can be arranged to provide an absolute wavelength reference by being arranged to have a characteristic transmission spectrum with periodic peaks at desired wavelengths.

In some aspects of the present disclosure, a system is described that can include a first photo-detector including a first optical element having a partially reflective coating on a front surface of the first optical element that is arranged to receive radiation from a wavelength tunable laser; an etalon arranged to receive at least a portion of the radiation partially reflected from the front surface of the first optical element; a second photo-detector including a second optical element having an anti-reflection coating on a front surface of the second optical element that is arranged to receive radiation from the etalon; and a digital signal processor arranged to receive and process data from the first and the second photo-detectors and to transmit a control signal to the laser to control the operational wavelength of the radiation in a feedback loop.

Additional embodiments and advantages of the disclosure will be set forth in part in the description which follows, and can be learned by practice of the disclosure. The embodiments and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the disclosure and, together with the description, serve to explain the principles of the disclosure.

### BRIEF DESCRIPTION OF THE DRAWINGS

FIG. 1 shows an example laser system including a wavelength locking module in accordance with aspects of the present disclosure.

FIG. 2 shows a detailed view of wavelength locking structure of FIG. 1.

FIGS. 3a and 3b show example apertures of a photo-detector and beam profile on second photo-detector in accordance with aspects of the present disclosure.

FIG. 4a shows a typical transmission spectrum of an Etalon around 1550 nm and wavelength locking mechanism based on the slope of transmittance in accordance with aspects of the present disclosure.

FIG. 4b shows the locking wavelength range of FIG. 4a as shown between two vertical dash lines in accordance with aspects of the present disclosure.

### DESCRIPTION OF THE EMBODIMENTS

Reference will now be made in detail to various exemplary embodiments of the present application, examples of which are illustrated in the accompanying drawings. Wherever possible, the same reference numbers will be used throughout the drawings to refer to the same or like parts.

In accordance with some aspects of the present disclosure, a laser wavelength locker is described. The wavelength locker includes a first photo-detector, an etalon and a second photo-detector. The first photo-detector includes a first optical element having a partially reflective front surface that is arranged to function as beam splitter. In other words, radiation from the laser can be split by the first optical element into a transmitted portion that is detected by a sensing element within the first photo-detector and a reflected portion that is directed to the etalon. The etalon is arranged to function as an absolute wavelength reference. Radiation emerging from the etalon is directed to the second photo-detector, which includes a second optical element having an anti-reflection coating thereon, such that reflections off of the second optical element can be minimized.

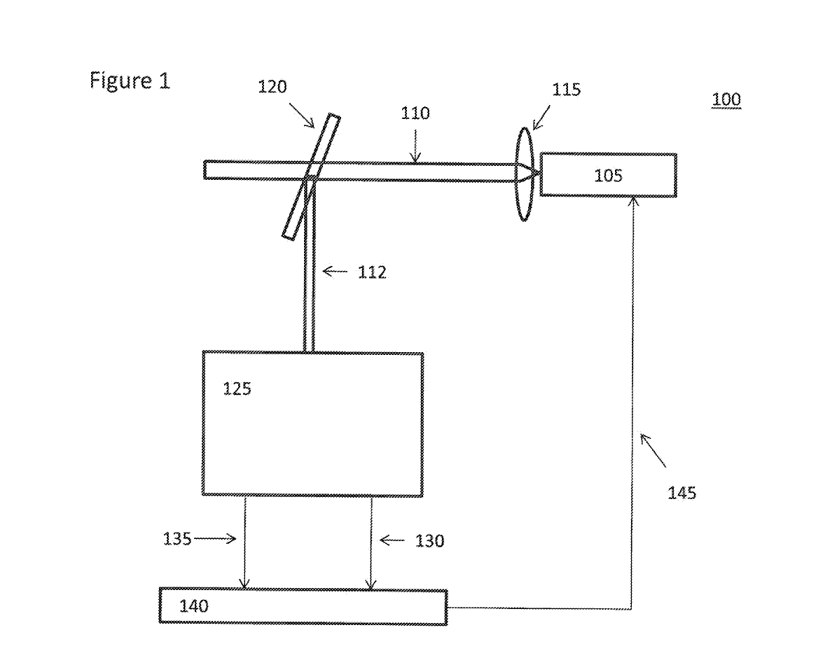

FIG. 1 shows an example laser system 100 including the laser wavelength locker 125 in accordance with aspects of the present disclosure. Laser 105 produces radiation 110 that is collimated by lens 115 and split by beam splitter 120. Radiation 112 reflected by beam splitter 120 is directed to laser wavelength locker 125, which is arranged to produce signals 130 and 135 that are supplied to processor 140. Processor 140, for example digital signal processor, can be arranged to produce a control signal that is supplied to laser 105 to provide precise and stable control of an operational wavelength produced by laser 105.

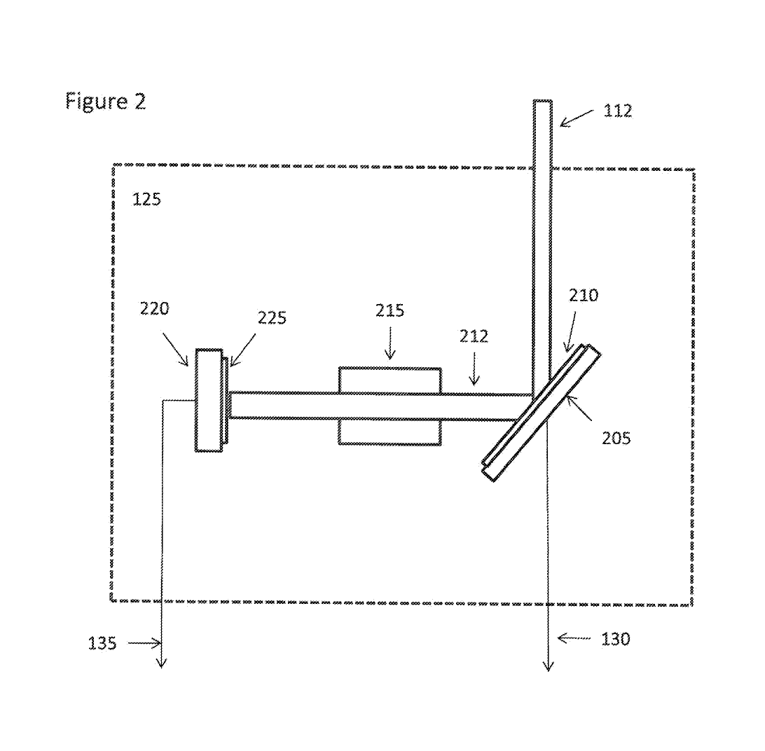

FIG. 2 shows the laser wavelength locker 125 in more detail. Radiation 112 enters laser wavelength locker 125 through an aperture (not shown) and is received by first photo-detector 205. First photo-detector 205 includes a partially reflecting surface 210 that is arranged to function like a beam-splitter by allowing a portion of radiation 112 to be transmitted and detected on a sensing element (not shown) of first photo-detector 205 and reflecting a portion of the radiation as 212. In some aspects, the radiation 112 can be reflected by partially reflecting surface 210 by a nature Fresnel reflection due to high refractive index contrast between the III-V materials that are typically used to make the photo-detector and air. Additionally or alternatively, the radiation 112 can be reflected by using a designed reflection coating on first photo-detector.

Etalon 215 receives radiation 212 and can be arranged to have certain characteristic transmission spectrum with periodic peaks at desired wavelengths or ITU grids defined in telecommunication, as would be known by one of ordinary skill in the art.

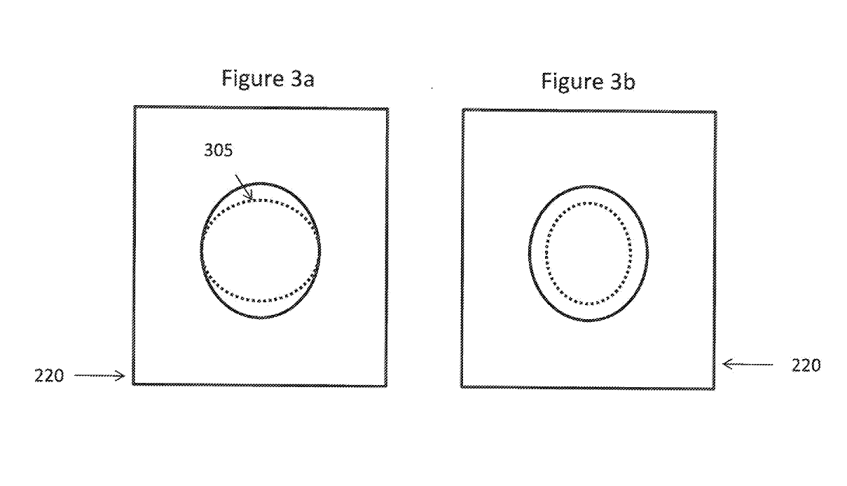

Second photo-detector 220 includes an anti-reflection coating 225 and is arranged to receive radiation transmitted by etalon 215. Second photo-detector 220 can be of same or slightly large active aperture than first photo-detector 205, which allows full capture of the light reflected from partially reflecting surface 210 because of its zero degree incident angle design, as shown in FIG. 3b. In some aspects of the present disclosure, second photo-detector 220 can be arranged to have a small tilting angle 305 against the incident beam in order to avoid any light to be reflected back to laser 105, as shown in FIG. 3a.

Anti-reflection coating 225 on second photo-detector 220 can be arranged to provide increased light absorption on sensing element (not shown) of second photo-detector 220 and to reduce or eliminate unwanted reflections off of second photo-detector 220 that may cause errors in laser wavelength locker 125.

In some aspects of the present disclosure, first photo-detector 205, etalon 215 and second photo-detector 220 can be bonded on a sub-mount or carrier to become a standard alone unit. In some aspects of the present disclosure, laser wavelength locker 125 can be arranged on a thermoelectrically cooled (TEC) structure that can maintain a substantially constant temperature at all times of the laser operation to address any thermal impact or temperature effect.

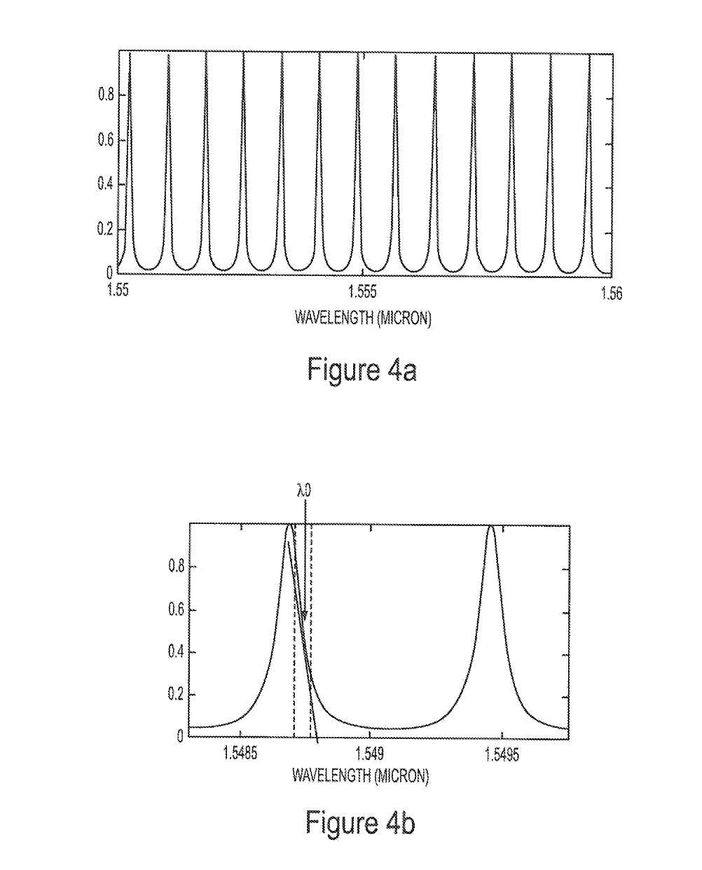

Signals or photo-currents 130 and 135 of both first and second photo-detectors 205 and 220 can be collected and feed to processor 140 for data processing and analysis to determine the wavelength of radiation 110 produced by laser 105. The photo-currents can also be used as a power monitor of the laser through a pre-calibration procedure. Wavelength analysis can done through comparison to known etalon 215 spectrum data, as shown in FIGS. 4a and 4b, which can be stored in a memory processor 140. Based on a desired operational wavelength, processor 140 can tune laser 105 to produce a particular wavelength or range of wavelengths based on feedback loop 145.

Wavelength locking can be done through a digital processing of the transmittance of laser beam through the etalon, i.e., the ratio of photocurrent from first photo-detector 205 to second photo-detector 220, to the known spectrum of the etalon pre-stored in a memory of processor 140, shown in FIGS. 4 a and 4b. When doing so, the most accurate and sensitive spectrum region to lock laser to a channel tends to be on the right side of each peak, i.e., the region with negative slope. The wavelength offset between the peak and the locking wavelength can be pre-determined through calibration in control algorithm.

In accordance with laser wavelength locker 125, first photo-detector 205 can function as the system aperture, and thus, both the first and the second photo-detectors 205 and 220 will have same photon capture aperture as shown in FIGS. 3a and 3b. This can provide a more stable and robust performance and high uniformity even under the variation of incoming beam pointing. Additionally, laser wavelength locker 125 can provide benefits including 1) low component cost and less process steps since no beam splitter is needed, 2) same capture aperture of photons is maintained at both photo-detectors for improved locking accuracy, 3) small form factor for application where device size and space is limited.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, in describing representative embodiments of the present disclosure, the specification may have presented the method and/or process of the present disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequence may be varied and still remain within the spirit and scope of the present disclosure.

Any of the functions described as being performed by a module, component or system can in some embodiments be performed by one or more other modules, component or system. One or more functions described as being performed by different modules, components or systems can be combined to be performed by one or more common module, component or system.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A method comprising:
controlling an operational wavelength of a wavelength tunable laser by:
receiving radiation from the laser at first photo-detector including a first optical element having a partially reflective coating on a front surface of the first optical element;
receiving at least a portion of the radiation partially reflected from the front surface of the first optical element at an etalon;
receiving radiation from the etalon at a second photo-detector including a second optical element having an anti-reflection coating on a front surface of the second optical element;
determining, by processor, a control signal to be applied to the laser to control the operational wavelength of the radiation based on data from the first and the second photo-detectors; and
transmitting the control signal to the laser to control the operational wavelength of the radiation.

2. The method according to claim 1, wherein the etalon is a solid state etalon.

3. The method according to claim 2, wherein the solid state etalon includes a solid state Fabry-Perot cavity.

4. The method according to claim 1, wherein the wavelength tunable laser is arranged to produce an optical signal for wavelength division multiplexing for optical communication.

5. The method according to claim 1, further comprising arranging each of the first and the second photo-detectors and the etalon on separate sub-assemblies.

6. The method according to claim 1, wherein the partially reflective coating on the first optical element reflects 50% of the incident light.

7. The method according to claim wherein the anti-reflection coating on the second optical element permits a maxima transmission.

8. The method according to claim 1, wherein the second photo-detector includes an aperture that includes a dimension that is equal to or larger than an aperture of the first photo-detector.

9. The method according to claim 1, wherein the processor includes a digital signal processor.

10. The method according to claim 1, wherein the processor includes a memory that is arranged to store a known spectrum of the etalon.

11. The method according to claim 1, wherein the etalon is arranged to provide an absolute wavelength reference by being arranged to have a characteristic transmission spectrum with periodic peaks at desired wavelengths.

12. A system comprising:
a first photo-detector including a first optical element having a partially reflective coating on a front surface of the first optical element that is arranged to receive radiation from a wavelength tunable laser;
an etalon arranged to receive at least a portion of the radiation partially reflected from the front surface of the first optical element;
a second photo-detector including a second optical element having an anti-reflection coating on a front surface of the second optical element that is arranged to receive radiation from the etalon; and
a digital signal processor arranged to receive and process data from the first and the second photo-detectors and to transmit a control signal to the laser to control the operational wavelength of the radiation in a feedback loop.

13. The system according to claim 12, wherein the etalon is a solid state etalon.

14. The system according to claim 13, wherein the solid state etalon includes a solid state Fabry-Perot cavity.

15. The system according to claim 12, wherein the wavelength tunable laser is arranged to produce an optical signal for wavelength division multiplexing for optical communication.

16. The system according to claim 12, wherein each of the first and the second photo-detectors and the etalon on arranged on separate sub-assemblies.

17. The system according to claim 12, wherein the partially reflective coating on the first optical element reflects 50% of the incident light.

18. The system according to claim 12, wherein the anti-reflection coating on the second optical element permits a maxima transmission.

19. The system according to claim 12, wherein the second photo-detector includes an aperture that includes a dimension that is equal to or larger than an aperture of the first photo-detector.

20. The system according to claim 12, wherein the processor includes a digital signal processor.

21. The system according to claim 12, wherein the processor includes a memory that is arranged to store a known spectrum of the etalon.

22. The system according to claim 12, wherein the etalon is arranged to provide an absolute wavelength reference by being arranged to have a characteristic transmission spectrum with periodic peaks at desired wavelengths.
